(19) United States
(12) Patent Application Publication
(10) Pub. No.: US 2022/0211089 A1
(43) Pub. Date: Jul. 7, 2022

(54) MOUTHFEEL AND ASTRINGENCY MODULATION IN COMPOSITIONS AND METHODS OF MODULATING MOUTHFEEL AND ASTRINGENCY IN THE SAME

(71) Applicant: Givaudan SA, VERNIER (CH)

(72) Inventors: Ioana Maria UNGUREANU, Cincinnati, OH (US); David POTTS, Cincinnati, OH (US); Sophie CHERIOT, Duebendorf (CH); Yosuke ONUMA, Cincinnati, OH (US)

(21) Appl. No.: 17/635,727

(22) PCT Filed: Sep. 9, 2020
(86) PCT No.: PCT/EP2020/075159

§ 371 Date: Feb. 16, 2022

Related U.S. Application Data
(60) Provisional application No. 62/898,100, filed on Sep. 10, 2019.

(51) Int. Cl. A23L 27/00; A23F 3/16; C12G 1/00; A23C 9/13; A23J 3/22; A23L 2/56

(52) U.S. Cl. CPC A23L 27/84; A23L 27/86; A23F 3/163; C12G 1/00; A23V 2002/00; A23J 3/227; A23L 2/56; C12G 2200/21; A23C 9/1307

(57) ABSTRACT

A method of improving mouthfeel and masking perceived astringency and undesired off-notes imparted by a consumable composition or additive, including the step of adding to the consumable or additive an astringency-masking amount of hyaluronic acid and/or salt thereof, wherein the hyaluronic acid and/or salt thereof has an average molecular weight of at least 500 kDa. Additionally disclosed is a food or beverage additive comprising at least one astringent component and an astringency-masking amount of hyaluronic acid and/or salt thereof. Further disclosed is a consumable composition comprising a consumable base, at least one astringent component and an astringency-masking amount of hyaluronic acid and/or salt thereof.

### TECHNICAL FIELD

The present disclosure relates to compositions having improved mouthfeel properties and a reduced or eliminated perception of astringency and methods of improving mouthfeel and reducing or eliminating a perception of astringency in compositions such as food and beverages.

### BACKGROUND

Astringency is a common and costly problem for the food and beverage industry. Astringency is defined by the American Society for Testing and Materials (ASTM, 2004) as the complex of sensations due to shirking, drawing or puckering of the epithelium as a result of exposure to substances such as alums and tannins. It is believed that astringent molecules react with salivary proteins, especially proline-rich proteins and glycoproteins that act as natural lubricants such as mucins, causing them to precipitate and aggregate, and the resulting loss of lubricity leads to the rough, “sandpapery”, or dry sensation associated with astringency in the mouth.

Astringency can be intrinsically present in consumables. The most common examples are astringency in certain consumables such as tea, wine, yogurt and plant proteins such as soy and pea proteins. There are many naturally occurring bioactive compounds that although eliciting astringency, nevertheless have positive health effects. These compounds include, for example, flavanoids, polyphenols, peptides, minerals or terpenes. Astringency can also be introduced into consumables as the result of adding certain ingredients such as vitamins, minerals, amino acids, proteins, peptides or antioxidants. All of these ingredients might be employed as additives with the intention of improving the health and safety of food or for reasons of nourishment, but they can also carry with them a perception of astringency, undesired mouthfeel properties and/or off-tastes.

Current solutions to avoid astringency or off-tastes in consumables are limited to adding sugars, salts, flavorings, spices, etc. Such attempts essentially provide a distraction from the astringency or off-taste and hide or overwhelm the desired flavor components present in the consumable. The relatively recent tendency to reduce or eliminate basic ingredients like salt or sugar from food for reasons related to health and wellness, as well as the increased use of functional ingredients and nutraceuticals, has also increased the need for new taste-masking or mouthfeel-modulating technologies. There has also been a desire to reduce or eliminate astringency and off-tastes, and improve mouthfeel properties, by the addition of materials that are not in themselves standard flavor ingredients, that is, they do not possess a desirable taste, if any, to be suitable as flavor ingredient, but reduce or eliminate astringency and off-tastes, and improve mouthfeel properties, when used in low concentrations.

Mouthfeel (or “mouth feel”) refers to the physical sensations experienced or felt in the mouth that are created by food and beverages, or compositions added to food or beverages. Mouthfeel may refer to textures that come into contact with the tongue, roof of the mouth, teeth, gums, or throat. Mouthfeel is considered to be distinct from taste/flavor, but is considered to have an equal or even greater impact on a person's enjoyment or preference for certain foods over others. Typical mouthfeel descriptors used to describe perceived sensations include acidity (metallic, citrusy, bright), density (close, airy), dryness (arid, scorched), graininess (particulate, powdery, dusty, grainy, chalky), gumminess (chewy, tough), hardness (crunchy, soft), heaviness (full, weighty), irritation (prickly, stinging), mouth coating (oily, buttery), roughness (abrasive, textured), slipperiness (slimy, stringy), smoothness (satiny, velvety), uniformity (even, uneven) and viscosity (full-bodied, light-bodied).

Accordingly, there is a demand for improving mouthfeel and reducing perceptions of astringency caused by consumables or certain ingredients or compositions that are added to consumables, while at the same time preserving or enhancing the desired mouthfeel and organoleptic properties of such consumables.

### SUMMARY

Disclosed is a method of masking perceived astringency and undesired off-notes imparted by a consumable composition or an additive of the consumable, including the step of adding to the consumable or additive an astringency-masking amount of hyaluronic acid and/or salt thereof, wherein the hyaluronic acid and/or salt thereof has an average molecular weight of at least 500 kDa.

Disclosed is a method of improving the mouthfeel of a consumable composition or an additive of the consumable, including the step of adding to the consumable or additive an astringency-masking amount of hyaluronic acid and/or salt thereof, wherein the hyaluronic acid and/or salt thereof has an average molecular weight of at least 500 kDa.

Additionally disclosed is a food or beverage additive comprising at least one component that imparts an undesired off-taste or astringency and an astringency-masking amount of hyaluronic acid and/or salt thereof, wherein the hyaluronic acid and/or salt thereof has an average molecular weight of at least 500 kDa.

Further disclosed is a consumable composition comprising at least one component that imparts an undesired off-taste or astringency and an astringency-masking amount of hyaluronic acid and/or salt thereof, wherein the hyaluronic acid and/or salt thereof has an average molecular weight of at least 500 kDa.

These and other features, aspects and advantages of specific embodiments will become evident to those skilled in the art from a reading of the present disclosure.

### DETAILED DESCRIPTION

The following text sets forth a broad description of numerous different embodiments of the present disclosure. The description is to be construed as exemplary only and does not describe every possible embodiment since describing every possible embodiment would be impractical, if not impossible. It will be understood that any feature, characteristic, component, composition, ingredient, product, step or methodology described herein can be deleted, combined with or substituted for, in whole or part, any other feature, characteristic, component, composition, ingredient, product, step or methodology described herein. Numerous alternative embodiments could be implemented, using either current technology or technology developed after the filing date of this application, which would still fall within the scope of the claims. All publications and patents cited herein are incorporated herein by reference.

An undesirable mouthfeel can be seriously disadvantageous to an otherwise desirably-flavored composition. As used herein, “mouthfeel” refers to physical sensations in the mouth produced by a food, beverage or ingredient, including, but not limited to, heaviness, thickness, viscosity, wetness, smoothness, filminess, dryness, and mouth coating. It has now been unexpectedly discovered that undesirable mouthfeel properties including, but not limited to, astringency perception can be improved by incorporating an astringency-masking amount of hyaluronic acid and/or salt thereof into a composition, wherein the hyaluronic acid and/or salt thereof has an average molecular weight of at least 500 kDa.

Disclosed is a method of masking perceived astringency and undesired off-notes imparted by a consumable composition or an additive of the consumable, including the step of adding to the consumable or additive an astringency-masking amount of hyaluronic acid and/or salt thereof, wherein the hyaluronic acid and/or salt thereof has an average molecular weight of at least 500 kDa. Surprisingly, it has been found that the inclusion of hyaluronic acid and/or salt thereof having a certain average molecular weight and being present in a certain concentration reduces or eliminates the perception of astringency and improves the overall mouthfeel of consumables or additives containing at least one component that imparts astringency. As used herein, the term “astringency” refers to dry, tightening, and/or puckering sensations in the oral cavity of a subject.

It has also been found that hyaluronic acid and/or salt thereof having a certain average molecular weight and being present in a certain concentration also enhances other mouthfeel characteristics, such as filminess. As used herein, the term “filminess” refers to the capacity of a substance to coat the oral cavity with a thin layer, giving a pleasant overall sensation. Filminess can also be considered similar to mouthcoating, but resulting in a thinner, more pleasant layer.

Without being limited by theory, it is believed that salivary proteins such as mucins are protected from precipitation and aggregation by hyaluronic acid and/or salt thereof having a certain average molecular weight and being present at a certain concentration, thereby maintaining the lubricity of oral tissues and moisture by salivary proteins. It is also believed that astringent molecules often form aggregates with mucins leading to an astringency perception. Similar aggregates can be formed between astringent compounds and hyaluronic acids. The hyaluronic acids are believed to strongly interact (for example, dipolar, acid-base, non-covalent interactions) with astringent substances, shielding a significant number of interaction sites. This interaction will reduce the ability of astringent substances to precipitate mucins, resulting in a reduced astringency perception.

It has also been found that compositions according to the present disclosure may be used for achieving an increased perception of saltiness, sweetness and/or umami even in cases where the salt content or sugar content in consumables is reduced.

Hyaluronic acid (also referred to as HA or hyaluronan) is classified as a glycosaminoglycan (GAG). GAGS are long, linear (unbranched) polysaccharides consisting of repeating disaccharides composed of glucuronic acid and glucosamine. Hyaluronic acid is found ubiquitously throughout the body, and either directly or indirectly involved in every physiological function of the body. Hyaluronan is found in dense concentrations in cartilage, synovial fluid, skin, vertebral discs, bones, urinary tract, cardiac valves, eyes, and various other soft tissues.

The primary structure of hyaluronic acid consists of a repetitive disaccharide unit, of sodium glucuronate and N-acetyl glucosamine bound by a β(1-3) bond. These units are linked with a β(1-4) bond. The primary structure of hyaluronic acid is reproduced below:

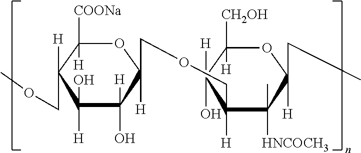

Hyaluronic acid may be extracted from natural tissues including the connective tissue of vertebrates, from the human umbilical cord and from rooster combs. It is also prepared by microbiological methods to minimize the potential risk of transferring infectious agents, and to increase product uniformity, quality and availability. It has a wide molecular weight spectrum which can reach 15,000 kDa and above, depending on the method for its production. Hyaluronic acid is known to be used as the sodium or potassium salt in human therapy and in cosmetics: exogenous application of hyaluronic acid has a beneficial effect favoring connective organization and is also effective in reducing or eliminating inflammatory processes induced by germs producing hyaluronase, reduces excessive capillary permeability, and accelerates tissue repair processes.

According to certain embodiments, the hyaluronic acid and/or salt thereof is produced by microbial fermentation, such as streptococcal fermentation. Microbially fermented hyaluronic acid and/or salt thereof may be produced from Streptococcus zooepidemicus. Producing hyaluronic acid or salt thereof by microbial fermentation may result in more consistent molecular profile, molecular weight and narrow polydispersity. According to certain embodiments, lactic bacteria is used to produce the hyaluronic acid and/or salt thereof.

According to certain embodiments, recombinant hyaluronic acid and/or salt thereof may be utilized. Both Gram-positive and Gram-negative bacteria can utilized as hosts, including Bacillus sp., Lactococcus lactis, Agrobacterium sp., and Escherichia coli to produce the recombinant hyaluronic acid and/or salt thereof. Any and all known methods may be used to produce the hyaluronic acid and/or salt thereof.

According to certain embodiments, bio-fermented sodium hyaluronate is produced by fermenting selected Streptococcus zooepidemicus bacterial strains; selecting the sodium hyaluronate crude product obtained from fermentation; purifying the crude product by filtration; precipitating sodium hyaluronate with an organic solvent; and drying.

According to certain embodiments, hyaluronic acid or salt thereof is obtained by a natural, bio-fermentation process of wheat stalks and purified with a bio-sourced purification solvent such as ethanol.

Culture conditions, such as pH, temperature, agitation speed, aeration rate, shear stress, dissolved oxygen, and bioreactor type significantly influence the microbial hyaluronic acid production. The pH and temperature for hyaluronic acid production by S. zooepidemicus are typically at about 7.0 and 37° C., respectively. Various fermentation modes, such as batch, repeated batch, fed-batch, and continuous culture may be used to produce the hyaluronic acid and/or salt.

The hyaluronic acid and/or salt thereof may be in the form of an emulsion, a solution, or a powder. According to certain embodiments, the hyaluronic acid and/or salt thereof is in the form of a powder. If hyaluronic acid and/or salt thereof is used in the form of a powder, the powder form can be produced by a dispersive evaporation process, such as a spray drying process. According to certain embodiments, the hyaluronic acid and/or salt thereof is in the form of a spray-dried powder.

The hyaluronic acid may be in the form of the free acid or may be a salt with an alkali metal (sodium, potassium, lithium) or alkaline earth metal (calcium, barium, strontium). According to certain embodiments, the hyaluronate is sodium hyaluronate.

According to certain embodiments, the hyaluronic acid and/or salt thereof has an average molecular weight of at least 500 kDa. According to certain embodiments, the hyaluronic acid and/or salt thereof has an average molecular weight of at least 500 kDa to about 5,000 kDa. According to certain embodiments, the hyaluronic acid and/or salt thereof has an average molecular weight of at least 500 kDa to about 2,000 kDa. According to certain embodiments, the hyaluronic acid and/or salt thereof has an average molecular weight of at least 500 kDa to about 1,500 kDa. According to certain embodiments, the hyaluronic acid and/or salt thereof has an average molecular weight of greater than 500 kDa to about 1,000 kDa. According to certain embodiments, the hyaluronic acid and/or salt thereof has an average molecular weight of greater than 750 kDa to about 1,500 kDa. According to certain embodiments, the hyaluronic acid and/or salt thereof has an average molecular weight of greater than 750 kDa to about 1,000 kDa. According to certain embodiments, the hyaluronate salt is sodium hyaluronate comprising an average molecular weight of about 1,000 to about 1,400 kDa.

According to certain embodiments, the hyaluronic acid and/or salt thereof has an average molecular weight of at least 500 kDa to about 750 kDa. According to certain embodiments, the hyaluronic acid and/or salt thereof has an average molecular weight of at least 750 kDa to about 1,250 kDa. According to certain embodiments, the hyaluronic acid and/or salt thereof has an average molecular weight of at least 1,000 kDa to about 1,500 kDa. According to certain embodiments, the hyaluronic acid and/or salt thereof has an average molecular weight of at least 1,000 kDa to about 1,400 kDa. According to certain embodiments, the hyaluronic acid and/or salt thereof has an average molecular weight of at least 1,100 kDa to about 1,300 kDa. As used herein, the phrase “average molecular weight” is meant to refer to the weight average molecular weight, unless noted otherwise.

Without limitation, suitable hyaluronic acid or salts thereof are commercially available under the trademark CRISTALHYAL® from Givaudan SA (Switzerland). Similar materials are also commercially available from a variety of sources.

The amount in which hyaluronic acid and/or salt thereof may be added to a consumable or additive may vary within wide limits and depends, inter alia, on the nature of the consumable or additive, on the particular desired mouthfeel or astringency-modifying effect, as well as the nature and concentration of the ingredient or ingredients in the consumable or additive that are responsible for the astringency that must be eliminated, suppressed or reduced. It is well within the purview of the person skilled in the art to decide on suitable quantities of the hyaluronic acid and/or salt thereof to incorporate into a consumable or additive depending on the end use and desired effect.

According to certain embodiments, the amount of hyaluronic acid and/or salt thereof present in the consumable or additive may be in a concentration of from at least about 1 ppm to about 10,000 ppm. According to certain embodiments, the amount of hyaluronic acid and/or salt thereof present in the consumable or additive may be in a concentration of from about 50 ppm to about 1,000 ppm. According to certain embodiments, the amount of hyaluronic acid and/or salt thereof present in the consumable or additive may be in a concentration of from about 50 ppm to about 1000 ppm. According to certain embodiments, the amount of hyaluronic acid and/or salt thereof is present in the consumable or additive may be in a concentration of from about 100 ppm to about 800 ppm. According to certain embodiments, the amount of hyaluronic acid and/or salt thereof is present in the consumable or additive may be in a concentration of from about 200 ppm to about 600 ppm. According to certain embodiments, the amount of hyaluronic acid and/or salt thereof is present in the consumable or additive may be in a concentration of from about 200 ppm to about 500 ppm. According to certain embodiments, the amount of hyaluronic acid and/or salt thereof is present in the consumable or additive may be in a concentration of from about 200 ppm to about 400 ppm. According to certain embodiments, the amount of hyaluronic acid and/or salt thereof is present in the consumable or additive may be in a concentration of from about 225 ppm to about 325 ppm. According to certain embodiments, the amount of hyaluronic acid and/or salt thereof is present in the consumable or additive may be in a concentration of from about 50 ppm to about 500 ppm.

According to certain embodiments, the amount of hyaluronic acid and/or salt thereof present in the consumable or additive may be in a concentration of from about 50 ppm to about 600 ppm, or from about 125 ppm to about 550 ppm, or from about 150 ppm to about 500 ppm, or from about 250 ppm to about 400 ppm, or from about 200 ppm to about 350 ppm, or from about 225 ppm to about 300 ppm, or from about 230 ppm to about 270 ppm.

When expressed as “ppm”, the concentration is parts per million by weight based on the total weight of the consumable or additive, as the situation dictates. It should be understood that when a range of values is described in the present disclosure, it is intended that any and every value within the range, including the end points, is to be considered as having been disclosed. For example, “a range of from 100 ppm to 1000 ppm” of hyaluronic acid and/or salt thereof is to be read as indicating each and every possible number along the continuum between 100 and 1000. It is to be understood that the inventors appreciate and understand that any and all values within the range are to be considered to have been specified, and that the inventors have possession of the entire range and all the values within the range.

In the present disclosure, the term “about” used in connection with a value is inclusive of the stated value and has the meaning dictated by the context. For example, it includes at least the degree of error associated with the measurement of the particular value. One of ordinary skill in the art would understand the term “about” is used herein to mean that an amount of “about” of a recited value produces the desired degree of effectiveness in the compositions and/or methods of the present disclosure. One of ordinary skill in the art would further understand that the metes and bounds of “about” with respect to the value of a percentage, amount or quantity of any component in an embodiment can be determined by varying the value, determining the effectiveness of the compositions or methods for each value, and determining the range of values that produce compositions or methods with the desired degree of effectiveness in accordance with the present disclosure.

Also provided is a food or beverage additive comprising at least one component that imparts an undesired mouthfeel or off-taste or astringency and an astringency-masking amount of hyaluronic acid and/or salt thereof, wherein the hyaluronic acid and/or salt thereof has an weight average molecular weight of at least 500 kDa.

The articles “a,” “an,” and “the” are used herein to refer to one or to more than one (that is, at least one) of the grammatical object of the article. By way of example, “a compound” means one compound or more than one compound.

The consumable or additive may include a base. As used herein, the term “base” refers to all the ingredients necessary for the consumable or additive, apart from the hyaluronic acid and/or salt thereof. These will naturally vary in both nature and proportion, depending on the nature and use of the consumable or additive, but they are all well known to the art and may be used in art-recognized proportions. The formulation of such a base for every conceivable purpose is therefore within the ordinary skill of the art.

Without limitation, and only by way of illustration, suitable bases may include, anti-caking agents, anti-foaming agents, anti-oxidants, binders, colourants, diluents, disintegrants, emulsifiers, encapsulating agents or formulations, enzymes, fats, flavour-enhancers, flavouring agents, gums, polysaccharides, preservatives, proteins, solubilisers, solvents, stabilisers, sugar-derivatives, surfactants, sweetening agents, vitamins, waxes, and the like. Solvents which may be used are known to those skilled in the art and include e.g. water, ethanol, ethylene glycol, propylene glycol, glycerine and triacetin. Encapsulants and gums include maltodextrin, gum arabic, alginates, gelatine, modified starch, other polysaccharides, and proteins.

Examples of excipients, carriers, diluents or solvents for flavor compounds may be found e.g. in “Perfume and Flavour Materials of Natural Origin”, S. Arctander, Ed., Elizabeth, N.J., 1960; in “Perfume and Flavour Chemicals”, S. Arctander, Ed., Vol. I & II, Allured Publishing Corporation, Carol Stream, USA, 1994; in “Flavourings”, E. Ziegler and H. Ziegler (ed.), Wiley-VCH Weinheim, 1998, and “CTFA Cosmetic Ingredient Handbook”, J. M. Nikitakis (ed.), 1st ed., The Cosmetic, Toiletry and Fragrance Association, Inc., Washington, 1988.

According to certain embodiments, hyaluronic acid and/or salts thereof may be added to a consumable as part of an additive, wherein the additive comprises at least one flavor-providing ingredient. Hyaluronic acid and/or salts thereof may be added directly to a consumable or pre-mixed with certain ingredients of the consumable. For example, hyaluronic acid and/or salts thereof may be admixed with substances that impart astringency to form an additive that may be thereafter added to the remaining ingredients of the consumable.

Non-limiting examples of suitable flavor-providing ingredients include natural flavours, artificial flavours, spices, seasonings, and the like. These include synthetic flavor oils and flavoring aromatics and/or oils, oleoresins, essences, and distillates, and combinations thereof.

Flavor oils include spearmint oil, cinnamon oil, oil of wintergreen (methyl salicylate), peppermint oil, Japanese mint oil, clove oil, bay oil, anise oil, eucalyptus oil, thyme oil, cedar leaf oil, oil of nutmeg, allspice, oil of sage, mace, oil of bitter almonds, and cassia oil; useful flavoring agents include artificial, natural and synthetic fruit flavors such as vanilla, and citrus oils including lemon, orange, lime, grapefruit, yuzu, sudachi, and fruit essences including apple, pear, peach, grape, raspberry, blackberry, gooseberry, blueberry, strawberry, cherry, plum, prune, raisin, cola, guarana, neroli, pineapple, apricot, banana, melon, apricot, cherry, tropical fruit, mango, mangosteen, pomegranate, papaya, and so forth.

Additional exemplary flavors imparted by a flavor-producing ingredient may include a milk flavor, a butter flavor, a cheese flavor, a cream flavor, and a yogurt flavor, a vanilla flavor, tea or coffee flavors, such as a green tea flavor, an oolong tea flavor, a tea flavor, a cocoa flavor, a chocolate flavor, and a coffee flavor; mint flavors, such as a peppermint flavor, a spearmint flavor, and a Japanese mint flavor; spicy flavors, such as an asafetida flavor, an ajowan flavor, an anise flavor, an angelica flavor, a fennel flavor, an allspice flavor, a cinnamon flavor, a chamomile flavor, a mustard flavor, a cardamom flavor, a caraway flavor, a cumin flavor, a clove flavor, a pepper flavor, a coriander flavor, a sassafras flavor, a savory flavor, a Zanthoxyli Fructus flavor, a perilla flavor, a juniper berry flavor, a ginger flavor, a star anise flavor, a horseradish flavor, a thyme flavor, a tarragon flavor, a dill flavor, a capsicum flavor, a nutmeg flavor, a basil flavor, a marjoram flavor, a rosemary flavor, a bayleaf flavor, and a wasabi (Japanese horseradish) flavor; a nut flavor such as an almond flavor, a hazelnut flavor, a macadamia nut flavor, a peanut flavor, a pecan flavor, a pistachio flavor, and a walnut flavor; floral flavors; and vegetable flavors, such as an onion flavor, a garlic flavor, a cabbage flavor, a carrot flavor, a celery flavor, mushroom flavor, and a tomato flavor.

Generally any flavor-producing ingredient or food additive such as those described in “Chemicals Used in Food Processing”, Publication No 1274, pages 63-258, by the National Academy of Sciences, can be used.

Ancillary ingredients may be present to provide other benefits such as enhanced stability, ease of incorporation into a consumable or additive and enhanced nutritional value. Non-limiting typical examples of such ancillary ingredients include stabilizers, emulsifiers, preservatives, gums, starches, dextrins, vitamins and minerals, functional ingredients, salts, antioxidants, and polyunsaturated fatty acids. Particular examples are emulsifiers and carriers, useful in spray drying processes. Non-limiting examples of these are modified starches, such as Capsul™, and maltodextrin.

The additive may be a single ingredient or a blend of ingredients, or it may be encapsulated in any suitable encapsulant, such as those mentioned above. The additive may be prepared by any suitable method, such as spray drying, extrusion and fluidized bed drying.

Hyaluronic acid and/or salts thereof may be used in a wide variety of consumables or applications and is not restricted to any particular physical mode or product form. According to the present disclosure, the term “consumable” refers to products for consumption by a subject, typically via the oral cavity (although consumption may occur via non-oral means such as inhalation), for at least one of the purposes of enjoyment, nourishment, or health and wellness benefits. Consumables may be present in any form including, but not limited to, liquids, solids, semi-solids, tablets, capsules, lozenges, strips, powders, gels, gums, pastes, slurries, solutions, suspensions, syrups, aerosols and sprays. The term also refers to, for example, dietary and nutritional, and health and wellness supplements. Consumables include compositions that are placed within the oral cavity for a period of time before being discarded but not swallowed. It may be placed in the mouth before being consumed, or it may be held in the mouth for a period of time before being discarded. It has been found that, in conjunction with tea, dairy products, protein, tea, coffee, and sweetened compositions, astringency-masking effects of hyaluronic acid and/or salts thereof are especially enhanced.

Broadly, consumables include, but are not limited to, comestibles of all kinds, confectionery products, baked products, sweet products, savoury products, fermented products, dairy products, non-dairy products, beverages, nutraceuticals and pharmaceuticals.

Non-limiting examples of consumables include: wet/liquid soups regardless of concentration or container, including frozen soups. For the purpose of this definition soup(s) means a food prepared from meat, poultry, fish, vegetables, grains, fruit and other ingredients, cooked in a liquid which may include visible pieces of some or all of these ingredients. It may be clear (as a broth) or thick (as a chowder), smooth, pureed or chunky, ready-to-serve, semi-condensed or condensed and may be served hot or cold, as a first course or as the main course of a meal or as a between meal snack (sipped like a beverage), soup may be used as an ingredient for preparing other meal components and may range from broths (consomme) to sauces (cream or cheese-based soups); dehydrated and culinary foods, including cooking aid products such as: powders, granules, pastes, concentrated liquid products, including concentrated bouillon, bouillon and bouillon like products in pressed cubes, tablets or powder or granulated form, which are sold separately as a finished product or as an ingredient within a product, sauces and recipe mixes (regardless of technology); meal solutions products such as: dehydrated and freeze dried soups, including dehydrated soup mixes, dehydrated instant soups, dehydrated ready-to-cook soups, dehydrated or ambient preparations of ready-made dishes, meals and single serve entrees including pasta, potato and rice dishes; meal embellishment products such as: condiments, marinades, salad dressings, salad toppings, dips, breading, batter mixes, shelf stable spreads, barbecue sauces, liquid recipe mixes, concentrates, sauces or sauce mixes, including recipe mixes for salad, sold as a finished product or as an ingredient within a product, whether dehydrated, liquid or frozen; beverages, including beverage mixes and concentrates, including but not limited to, alcoholic and non-alcoholic ready to drink and dry powdered beverages, carbonated and non-carbonated beverages, e.g., sodas, fruit or vegetable juices, alcoholic and non-alcoholic beverages, teas such as green tea and black tea, wine such as red wine; confectionery products, e.g., cakes, cookies, pies, candies, chewing gums, gelatins, ice creams, sorbets, puddings, jams, jellies, salad dressings, and other condiments, cereal, and other breakfast foods, canned fruits and fruit sauces and the like.

In a particular embodiment, hyaluronic acid and/or salts thereof can reduce or remove the astringency imparted by certain consumables or additives that have reduced or no sugar content. In certain embodiments, the consumables or additives may include a non-nutritive sweetener. In certain embodiments, the non-nutritive sweetener is selected from the group consisting of a steviol glycoside, Lo Han Guo sweetener, rubusoside, siamenoside, monatin, curculin, glycyrrhizic acid, neohesperidin, dihydrochalcone, glycyrrhizin, glycyphyllin, phloridzin, trilobatin, phyllodulcin, brazzein, hernandulcin, osladin, polypodoside A, baiyunoside, pterocaryoside A and B, mukurozioside, thaumatin, monellin, mabinlins I and II, phlomisoside I, periandrin I, abrusoside A, and cyclocarioside I, mogroside IV, mogroside V, or combinations thereof. In some embodiments, the non-nutritive sweetener is a steviol glycoside. In particular embodiments, the steviol glycoside is selected from the group consisting of stevioside, rebaudioside A, rebaudioside B, rebaudioside C, rebaudioside D, rebaudioside E, rebaudioside F, rebaudioside G rebaudioside H rebaudioside I, rebaudioside J, rebaudioside K, rebaudioside L, rebaudioside M, rebaudioside N, rebaudioside O, rebaudioside P, rebaudioside Q, steviolbioside, dulcoside A, and combinations thereof.

Astringency may be formed as the result of one or more ingredients being added to, or present in, food or beverage products. Astringent substances are present in vast categories of consumables including, but not limited to, beverages such as tea and wine, dairy products, dessert products, savory products, salad dressings, sauces, condiments, alcoholic beverages, confections, gums, and medicaments. Astringency may be imparted by salts of multivalent metallic cations (aluminum, chromium, zinc, lead, calcium, magnesium, etc.), vegetable tannins (e.g., gallotannic acid), dehydrating agents (e.g., ethyl alcohol, acetone, glycerine), proteins, as well as a wide variety of organic compounds and mineral acids.

A typical example of a substance providing an astringent impression is green tea, which contains several polyphenols, known as catechins, which are known to be astringent, namely, catechin, epigallocatechin gallate, epigallocatechin, epicatechin gallate, epicatechin and their respective stereoisomers and derivatives. Other examples of substances that impart astringency are proteins, such as pea protein, soy protein and whey protein. Further examples of astringent imparting substances are the theaflavins of black tea, namely, theaflavin, theaflavin-3-gallate, theaflavin-3′-gallate, theaflavin-3,3′-digallate, and theaflavic acid. Further examples of astringent imparting substances are the tannins (or tannoids) in wine. The taste of some substances may be perceived as a mixture of bitterness and astringency. Thus, for example, the astringent taste of green tea, certain proteins and wine is sometimes perceived as a mixture of bitterness/astringency.

According to certain embodiments, the disclosed compositions and methods are used to reduce or eliminate astringency imparted by beverages. Exemplary beverages include, but are not limited to, flavoured water, soft drinks, fruit drinks, coffee-based drinks, tea-based drinks, juice-based drinks (includes fruit and vegetable), milk-based drinks, yoghurt drinks, gel drinks, carbonated or non-carbonated drinks, fountain drinks, frozen drinks, cola drinks, sports drinks, energy drinks, fortified/enhanced drinks, fermented drinks, smoothie drinks, powdered drinks, alcoholic or non-alcoholic drinks, and ready to drink liquid formulations of these beverages.

According to certain embodiments, the disclosed compositions and methods are used to reduce or eliminate astringency imparted by tea. According to certain embodiments, the disclosed compositions and methods are used to reduce or eliminate astringency imparted by green tea or black tea alone or in combination with other flavors/extracts. According to certain embodiments, the disclosed compositions and methods are used to reduce or eliminate astringency imparted by wine. According to certain embodiments, the disclosed compositions and methods are used to reduce or eliminate astringency imparted by red wine. According to certain embodiments, the disclosed compositions and methods are used to reduce or eliminate astringency imparted by protein. According to certain embodiments, the disclosed compositions and methods are used to reduce or eliminate astringency imparted by soy protein and/or pea protein.

According to certain embodiments, the astringency-masking compound is used to reduce or eliminate astringency imparted by dairy products, such as milk or yoghurt.

Exemplary dairy products include, but are not limited to, cheese, cheese sauces, cheese-based products, ice cream, impulse ice cream, single portion dairy ice cream, single portion water ice cream, multi-pack dairy ice cream, multi-pack water ice cream, take-home ice cream, take-home dairy ice cream, ice cream desserts, bulk ice cream, take-home water ice cream, frozen yoghurt, artisanal ice cream, milk, fresh/pasteurized milk, full fat fresh/pasteurized milk, semi skimmed fresh/pasteurized milk, long-life/uht milk, full fat long life/uht milk, semi skimmed long life/uht milk, fat-free long life/uht milk, goat milk, condensed/evaporated milk, plain condensed/evaporated milk, flavoured, functional and other condensed milk, flavoured milk drinks, dairy only flavoured milk drinks, flavoured milk drinks with fruit juice, soy milk, sour milk drinks, fermented dairy drinks, coffee whiteners, powder milk, flavoured powder milk drinks, cream, yoghurt, plain/natural yoghurt, flavoured yoghurt, fruited yoghurt, probiotic yoghurt, drinking yoghurt, regular drinking yoghurt, probiotic drinking yoghurt, chilled and shelf-stable desserts, dairy-based desserts, and soy-based desserts.

According to certain embodiments, the disclosed method is used to reduce or eliminate astringency imparted by non-animal derived protein such as plant protein. Exemplary plant proteins include soy protein and pea protein. As used herein, soy includes all consumables containing soy in any form, including soybean oil used either alone, in combination, for example as a nutraceutical, or as a medicament, soy bean curd, soy milk, soy butter or soy paste. The plant protein may comprise algae (such as spirulina), beans (such as black beans, canelli beans, kidney beans, lentil beans, lima beans, pinto beans, soy beans, white beans), broccoli, edamame, mycoprotein, nuts (such as almonds, brazil nuts, cashews, peanuts, pecans, hazelnuts, pine nuts, walnuts), peas (such as black eyed peas, chickpeas, green peas), potatoes, oatmeal, seeds (such as chia, flax, hemp, pumpkin, sesame, sunflower), seitan (i.e., wheat gluten-based), tempeh, tofu, and mixtures thereof. According to certain embodiments, the plant protein is a potato-derived protein.

According to another embodiment, the method may be used to improve or amplify the taste perception and aroma profile of consumables and deliver sufficient saltiness or sweetness in cases where the salt content or sugar content is reduced. In particular, hyaluronic acid and/or salts thereof can generate improved or increased perception of saltiness, sweetness and/or umami, which could not be achieved by any other compositions known in the art. Saltiness is a taste sensed when a salty substance such as sodium chloride is introduced into the mouth. Sweetness is a taste sensed when a sweet substance such as sugar, honey, maple syrup, erythritol, trehalose or aspartame is introduced into the mouth. Umami is a taste sensed when a substance such as glutamic acid or inosinic acid is introduced into the mouth similar to savory, brothy or meaty perceptions.

According to certain embodiments, the method may be used to reduce or eliminate astringency perception in meat analog products containing non-animal protein. “Meat analog” is a food product that approximates the aesthetic qualities and/or chemical characteristics of certain types of meat. The term Meat analogue includes those prepared with textured vegetable proteins (TVP), high moisture meat analogue (EMMA) and low moisture meat analogue (LMMA) products.

Food scientists have devoted much time developing methods for preparing acceptable meat-like food applications, such as beef, pork, poultry, fish, and shellfish analogs, from a wide variety of non-animal proteins. One such approach is texturization into fibrous meat analogs, for example, through extrusion processing. The resulting meat analog products exhibit improved meat-like visual appearance and improved texture.

### Meat Analog Composition and Extrusion Process

Meat analog products are produced with high moisture content and provide a product that simulates the fibrous structure of animal meat and has a desirable meat-like moisture, texture, mouthfeel, flavor and color.

Texturization of protein is the development of a texture or a structure via a process involving heat, and/or shear and the addition of water. The texture or structure will be formed by protein fibers that will provide a meat-like appearance and perception when consumed. The mechanism of texturization of proteins starts with the hydration and unfolding of a given protein by breaking intramolecular binding forces by heat and/or shear. The unfolded protein molecules are aligned and bound by shear, forming the characteristic fibers of a meat-like product. In one embodiment, polar side chains from amino acids form bonds with linear protein molecules and the bonds will align protein molecules, forming the characteristic fibers of a meat-like product.

To make non-animal proteins palatable, texturization into fibrous meat analogs, for example, through extrusion processing has been an accepted approach. Due to its versatility, high productivity, energy efficiency and low cost, extrusion processing is widely used in the modern food industry. Extrusion processing is a multi-step and multifunctional operation, which leads to mixing, hydration, shear, homogenization, compression, deaeration, pasteurization or sterilization, stream alignment, shaping, expansion and/or fiber formation. Ultimately, the non-animal protein, typically introduced to the extruder in the form of a dry blend, is processed to form a fibrous material.

More recent developments in extrusion technology have focused on using twin screw extruders under high moisture (40-80%) conditions for texturizing non-animal proteins into fibrous meat alternatives. In the high moisture twin screw process, also known as “wet extrusion”, the raw materials, predominantly non-animal proteins such as soy and/or pea protein, are mixed and fed into a twin-screw extruder, where a proper amount of water is dosed in and all ingredients are further blended and then melted by the thermo-mechanical action of the screws. The realignment of large protein molecules, the laminar flow, and the strong tendency of stratification within the extruder's long slit cooling die contribute to the formation of a fibrous structure. The resulting wet-extruded products tend to exhibit improved whole muscle meat-like visual appearance and improved palatability. Therefore, this extrusion technology shows promise for texturizing non-animal proteins to meet increasing consumer demands for healthy and tasty foods.

Texturization processes may also include spinning, simple shear flow, and simple shear flow and heat in a Couette Cell (“Couette Cell” technology). The spinning process consists of unfolding protein molecules in a high alkaline pH solution, and coagulating the unfolded protein molecules by spraying the protein alkaline solution into an acid bath. The spraying is made by a plate with numerous fine orifices. The protein coagulates forming fibers as soon as it gets in contact with the acid medium. The fibers are then washed to remove remaining acid and/or salts formed in the process. A Couette Cell is a cylinder-based device where the inner cylinder rotates and the outer cylinder is stationary, being easy to scale up. The Couette Cell operates under the same principle of forming protein fibers by subjecting the protein to heat and shear in the space between the stationary cylinder and the rotational cylinder.

With respect to simple shear flow and heat in a Couette Cell, this process can induce fibrous structural patterns to a granular mixture of non-animal proteins at mild process conditions. This process is described in “On the use of the Couette Cell technology for large scale production of textured soy-based meat replacers”, Journal of Food Engineering 169 (2016) 205-213, which is incorporated herein by reference.

Meat analog products having qualities (for example, texture, moisture, mouthfeel, flavor, and color) similar to that of whole muscle animal meat may be produced using non-animal proteins formed using extrusion under conditions of relatively high moisture. In one embodiment, meat analog products may include non-animal protein, one or more of flour, starch, and edible fiber, an edible lipid material.

In certain compositions, the amount of non-animal protein included in the mixture to be extruded includes no more than about 90% by weight of the dry ingredients. For example, the amount of non-animal protein present in the ingredients utilized to make meat analog products according to the present disclosure may range from about 3% to about 90% by weight of the dry ingredients. In another embodiment, the amount of non-animal protein present in the ingredients utilized to make meat analog products according to the present disclosure may range from about 10% to about 80% by weight of the dry ingredients. In a further embodiment, the amount of non-animal protein present in the dry ingredients utilized to make meat analog products according to the present disclosure may range from about 25% to about 50% by weight. In another further embodiment, the amount of non-animal protein present in the dry ingredients utilized to make meat analog products according to the present disclosure may be about 40%.

The term “dry ingredients” includes all the ingredients in the mixture to be extruded except for added water and ingredients added with the added water (i.e., the “wet ingredients”).

In one embodiment, the non-animal protein ingredients are isolated from soybeans. Suitable soybean derived protein-containing ingredients include soy protein isolate, soy protein concentrate, soy flour, and mixtures thereof. The soy protein materials may be derived from whole soybeans in accordance with methods generally known in the art. In another exemplary embodiment, the non-animal protein ingredients are isolated from grain, legume or pulses, seed and oilseed, nut, algal, mycoprotein or fungal protein, insects, leaf protein and combinations thereof as described herein.

In addition to the foregoing, the meat analog product includes water at a relatively high amount. In one embodiment, the total moisture level of the mixture extruded to make the meat analog product is controlled such that the meat analog product has a moisture content that is at least about 50% by weight. To achieve such a high moisture content, water is typically added to the ingredients. Although, a relatively high moisture content is desirable, it may not be desirable for the meat analog product to have a moisture content much greater than about 65%. As such, in one embodiment the amount of water added to the ingredients and the extrusion process parameters are controlled such that the meat analog product (following extrusion) has a moisture content that is from about 40% to about 65% by weight.

Among the suitable extrusion apparatuses useful in the practice of the described process is a commercially available double barrel, twin-screw extruder apparatus such as a Wenger TX 52 model manufactured by Wenger (Sabetha, Kans.).

The screws of a twin-screw extruder can rotate within the barrel in the same or opposite directions. Rotation of the screws in the same direction is referred to as single flow or co-rotating whereas rotation of the screws in opposite directions is referred to as double flow or counter-rotating. The speed of the screw or screws of the extruder may vary depending on the particular apparatus; however, it is typically from about 100 to about 450 revolutions per minute (rpm). Generally, as the screw speed increases, the density of the extrudate will decrease. The extrusion apparatus contains screws assembled from shafts and worm segments, as well as mixing lobe and ring-type shearing elements as recommended by the extrusion apparatus manufacturer for extruding non-animal protein material.

The extrusion apparatus generally comprises a plurality of heating zones through which the protein mixture is conveyed under mechanical pressure prior to exiting the extrusion apparatus through an extrusion die. The temperature in each successive heating zone generally exceeds the temperature of the previous heating zone by between about 10° C. to about 70° C. In one embodiment, the dry premix is transferred through multiple heating zones within the extrusion apparatus, with the protein mixture heated to a temperature of from about 25° C. to about 170° C. such that the molten extrusion mass enters the extrusion die at a temperature of from about 170° C. In one embodiment, the protein mixture is heated in the respective heating zones to temperatures of about 25° C., about 40° C., about 95° C., about 150° C. and about 170° C.

The pressure within the extruder barrel is typically between about 30 psig and about 500 psig, or more specifically between about 50 psig and about 300 psig. Generally, the pressure within the last two heating zones is between about 50 psig and about 500 psig, even more specifically between about 50 psig to about 300 psig. The barrel pressure is dependent on numerous factors including, for example, the extruder screw speed, feed rate of the mixture to the barrel, feed rate of water to the barrel, and the viscosity of the molten mass within the barrel.

Water along with additional “wet ingredients” are injected into the extruder barrel to hydrate the non-animal protein mixture and promote texturization of the proteins. As an aid in forming the molten extrusion mass, the water may act as a plasticizing agent. Water may be introduced to the extruder barrel via one or more injection jets. The rate of introduction of water to the barrel is generally controlled to promote production of an extrudate having the aforementioned desired characteristics, such as an extrudate with a moisture content as described above.

### Textured Vegetable Proteins (TVP)/Low Moisture Meat Analogue (LMMA)

Textured vegetable proteins (TVPs) can be defined as food products made from edible protein sources and characterised by having structural integrity and identifiable texture such that each unit will withstand hydration in cooking and other procedures used in preparing the food for consumption. A majority of TVPs produced today are produced by extrusion technology. These TVPs are often rehydrated with 60-65% moisture and blended with other ingredients including, but not limited to, binders, meats, other TVPs, flavours, excipient, fats, oils, or seasonings.

The low-moisture meat analog (LMMA) product is most often cut with an extruder knife at the extruder die to form the finished product size and shape. Drying after extrusion, to remove moisture, improves storage, handling, and shelf-stability. These LMMAs are often rehydrated with 60-70% moisture. Additionally, other food ingredient items can be added to improve finished product functionality and appearance, including, but not limited to, oil, other proteins, salt, seasonings, flavours, maskers, enhancers, or binders. Generally re-hydrated LMMA contains 40-80% moisture, 0-5% oil, 25-60% protein.

A typical formulation of LMMA contains water, soy concentrates, soy isolates, oil, a binder (e.g. cellulose, vital wheat gluten) and flavours, maskers, seasonings, etc. that provide a taste and texture closer to an animal meat product.

The disclosure is further described with reference to the following non-limiting examples.

### EXAMPLES

The following examples are given solely for the purpose of illustration and are not to be construed as limitations of the present invention, as many variations of the invention are possible without departing from the spirit and scope of the present disclosure.

### Example 1—Green Tea Extract Beverage

A first green tea extract beverage is prepared by mixing 5% sucrose, 0.05% citric acid, and 0.02% green tea extract containing 40% epigallocatechin gallate (“EGCG”)—dry weight in water.

A second green tea extract beverage was prepared with the same ingredients as the first green tea extract beverage except also contained sodium hyaluronate having an average molecular weight of from between 1000 to 1,400 kDa in a concentration of 250 ppm.

Eleven (11) expert sensory trained panelists familiar with paired comparison evaluated the two beverage compositions. The sensory test concluded on a perceived significant reduction in bitterness and astringency and a significant improvement in mouthfeel, particularly in filminess in the second beverage containing sodium hyaluronate as compared to the first beverage that did not contain hyaluronic acid or salt thereof.

Additional green tea extract beverages were prepared and tasted as follows. Beverages were prepared by mixing sodium hyaluronate having an average molecular weight of from between 1000 to 1,400 kDa in a concentration of 50 ppm and 100 ppm in a lemon flavoured green tea beverage (0.02% green tea extract, 0.05% citric acid, 5% sucrose, 0.05% natural lemonade flavor and water). Evaluations were performed by six (6) expert tasters in repetition. Samples containing hyaluronic acid were compared to a reference control lemon flavoured green tea beverage. Tasters found that the sample containing the hyaluronic acid at both levels, 50 ppm and 100 ppm, were slightly lower in astringency.

In another evaluation, beverages were prepared by mixing sodium hyaluronate having an average molecular weight of from between 1000 to 1,400 kDa in a concentration of 250 ppm in a lemon flavoured green tea beverage (0.02% green tea extract, 0.05% citric acid, 5% sucrose, 0.05% natural lemonade flavor and water). Evaluations were performed by twenty (20) expert tasters in repetition. Samples containing hyaluronic acid were compared to a reference control lemon flavoured green tea beverage. Tasters found that the sample containing the hyaluronic acid was clearly reduced in astringency. Additionally the majority of tasters reported increased rounding and smoothening of the product.

In another evaluation, beverages were prepared by mixing sodium hyaluronate having an average molecular weight of from between 1000 to 1,400 kDa in a concentration of 400 ppm in a lemon flavoured green tea beverage (0.02% green tea extract, 0.05% citric acid, 5% sucrose, 0.05% natural lemonade flavor and water). Evaluations were performed by 20 expert tasters in repitition. Samples containing hyaluronic acid were compared to a reference control lemon flavoured green tea beverage. Tasters found that the sample containing the hyaluronic acid was clearly reduced in astringency. Additionally the majority of tasters reported increased rounding and smoothening of the product.

In another evaluation, beverages were prepared by mixing sodium hyaluronate having an average molecular weight of from between 1000 to 1,400 kDa in a concentration of 1000 ppm in a lemon flavoured green tea beverage (0.02% green tea extract, 0.05% citric acid, 5% sucrose, 0.05% natural lemonade flavor and water). Evaluations were performed by 6 expert tasters in repetition. Samples containing hyaluronic acid were compared to a reference control lemon flavoured green tea beverage. Tasters found that the sample containing the hyaluronic acid was clearly reduced in astringency. Additionally the majority of tasters reported increased rounding and smoothening of the product.

### Example 2—Plain, Low Fat Yoghurt

Six (6) expert tasters evaluated a commercially available plain, low fat yoghurt composition that did not contain hyaluronic acid or salt thereof and compared it to the same yoghurt composition to which 250 ppm of sodium hyaluronate having an average molecular weight of from between 1000 to 1,400 kDa in a concentration of 250 ppm was added. The sensory test concluded on a perceived reduction in astringency, improvement in mouthfeel and a pleasant creaminess perception in the yoghurt containing sodium hyaluronate as compared to the yoghurt that did not contain hyaluronic acid or salt thereof.

### Example 3—Flavored, Sweetened, Low Fat Yoghurt

Six (6) expert tasters evaluated a commercially available flavored, sweetened, low fat (1% fat) strawberry yoghurt composition that did not contain hyaluronic acid or salt thereof and compared it to the same yoghurt composition to which 250 ppm of sodium hyaluronate having an average molecular weight of from between 1000 to 1,400 kDa was added. The sensory test concluded on a perceived reduction in astringency, improvement in mouthfeel and a pleasant creaminess perception in the yoghurt containing sodium hyaluronate as compared to the yoghurt that did not contain hyaluronic acid or salt thereof. Similar results were observed for similar yoghurt composition (2.6% added sugar, strawberry flavor) to which 100 ppm of sodium hyaluronate having an average molecular weight of from between 1000 to 1,400 kDa was added.

The impact of the addition of hyaluronic acid on astringency perception imparted by pea protein drinks was also evaluated.

### Pea Protein Beverage Sample Preparation

A pea protein beverage was prepared by dry blending pea protein isolate, sucrose and stabilizer. Cold, filtered water was added to the blended dry ingredients. The sample was mixed in a Silverson high shear mixer at 7500 RPM for 15 minutes. Any foam generated during the high shear mixing was permitted to settle for 1 hour and then skimmed from the sample. The pH of the sample was adjusted to be in the range of 6.8-7.0. Natural vanilla flavor was added to the pea protein beverage base sample and mixed for at least 1 hour or until fully incorporated in the sample. For samples containing the test astringency masker, the natural vanilla flavor and astringency masker were added to the samples, and mixed for at least 1 hour or until fully incorporated into the samples. The samples were homogenized via a 2-stage homogenization process and transferred to clean glass beverage bottles. The samples were thermally processed using a Miele Hotpack at 90° C. for 60 seconds. The samples were then cooled and stored at refrigerated temperatures (4-6° C.). The samples were removed from the refrigerated temperatures 1 hour before serving.

### Test Methodology

Ten (10) expert sensory trained panelists compared the base pea protein beverage (Example 4) that did not contain hyaluronic acid or salt thereof, and with the same pea protein beverage composition to which 50 ppm (Example 5) and 250 ppm (Example 6) of sodium hyaluronate having an average molecular weight of from between 1000 to 1,400 kDa was added.

The panel generated a list of aromatic, taste and mouthfeel descriptors relevant to the differentiation between the samples. The sensory panelists are trained to recognize such descriptors. Each expert panelist evaluated two (2) pairs of samples following a conventional multicriterial paired comparison test. For each pair of samples and each descriptor, the panelists identified the sample with the highest intensity. The panelists performed each test nine (9) times, under white light and blindly to ensure the reliability of the data. The samples were presented according to a complete balanced design to the panelists. Each of the two (2) pairs of samples was evaluated 90 times.

### Example 4

A pea protein beverage is prepared by mixing 3% pea protein isolate (Pisane® C9), 4% sucrose, 0.05% stabilizer (Kelcogel® HS-B), and 0.4% natural vanilla flavor—dry weight in water.

### Example 5

A pea protein beverage was prepared in accordance with Example 4. 0.005% (50 ppm) of sodium hyaluronate having an average molecular weight of from between 1000 to 1,400 kDa (Crystalhyal®) as a test astringency masker was added to the pea protein beverage. The panelists tasted the sample in accordance with the Test Methodology described herein. The sensory test concluded on a perceived significant increase in vanillic note of the added flavor and a significant decrease in mouth drying for the samples containing a low concentration (50 ppm) of Crystalhyal as compared to the pea protein beverage that did not contain the hyaluronic acid salt. The sensory test also concluded that the low concentration of the Crystalhyal tends to increase the thickness of the pea protein beverage.

### Example 6

A pea protein beverage was prepared in accordance with Example 4. 0.025% (250 ppm) of sodium hyaluronate having an average molecular weight of from between 1000 to 1,400 kDa (Crystalhyal®) as a test astringency masker was added to the pea protein beverage. The panelists tasted the sample in accordance with the Test Methodology described herein. The sensory test concluded on a perceived significant increase in the thick mouthfeel perception and the aromatics profile (pea/earthy/green/green cocoa) for the samples containing a high concentration (250 ppm) of Crystalhyal as compared to the pea protein beverage that did not contain the hyaluronic acid salt. The sensory test also concluded that the high concentration of the Crystalhyal tends to increase the filmy mouthfeel perception and decrease the dry mouth perception imparted by the pea protein beverage.

### Example 7—Chickpea Yoghurt

Hyaluronic acid was tested in an unflavored chickpea protein yoghurt by adding 100 ppm of sodium hyaluronate having an average molecular weight of from between 1000 to 1,400 kDa. Evaluations were performed by 4 expert tasters. Samples containing hyaluronic acid were compared to a reference control chickpea yogurt sample. Tasters found that the sample containing the hyaluronic acid was slightly lower in astringency and bitterness, higher in mouthcoating, slightly higher in sweetness, and slightly lower in sourness and perceived acidity.

### Example 8—Pea/Soy Meat Analogue

Hyaluronic acid was tested at 100 and 500 ppm in extruded meat analogue strips (pea and soy protein blend, 5% pea fiber, 1% salt, 1.5% safflower oil) by adding sodium hyaluronate having an average molecular weight of from between 1000 to 1,400 kDa. Evaluations were performed by 5 expert tasters. Samples containing hyaluronic acid were compared to a reference control meat analogue strip. Tasters found that the samples containing the hyaluronic acid at both levels, 100 and 500 ppm, were slightly lower in astringency.

### Example 9—Beef Bouillon

Hyaluronic acid was tested at 50, 100, 200, and 400 ppm in a commercial flavored beef bouillon by adding sodium hyaluronate having an average molecular weight of from between 1000 to 1,400 kDa. Evaluations were performed by 4 expert tasters. A sample containing hyaluronic acid were compared to a reference control beef bouillon. Tasters found that the samples containing the hyaluronic acid at 50 ppm had more body and fuller mouthfeel. At 100 ppm the sample had a richer and fattier mouthfeel and body. At 200 ppm the sample was stronger in mouthfeel and body. At 400 ppm higher mouthfeel, body, and fattiness was perceived.

### Example 10—Potato Chips

Hyaluronic acid was tested at 50, 100, and 200 ppm applied to commercial potato chip by adding sodium hyaluronate having an average molecular weight of from between 1000 to 1,400 kDa. Evaluations were performed by 6 expert tasters. Chip samples containing hyaluronic acid were compared to reference potato chips. Tasters found that the samples containing the hyaluronic acid at 50 ppm were stronger and had more lingering of umami and salty tastes. At 100 ppm, the hyaluronic acid sample was found to provide some slightly increased saltiness and fuller fattiness. The sample containing 200 ppm hyaluronic acid was slightly higher in fatty perception and had an enhanced rounder profile compared to that of the control sample.

### Example 11—Red Wine

Hyaluronic acid was tested at 250 ppm in a commercial red wine (13.7% alcohol) by adding sodium hyaluronate having an average molecular weight of from between 1000 to 1,400 kDa. Evaluations were performed by 5 expert tasters. Red wine containing hyaluronic acid was compared to a reference red wine. Tasters found that the samples containing the hyaluronic acid at 250 ppm were slightly lower in sourness, slightly higher in mouthcoating and slightly lower in astringency mouthfeel sensations.

### Example 12—White Wine

Hyaluronic acid was tested at 250 ppm in a commercial white wine (13.7% alcohol) by adding sodium hyaluronate having an average molecular weight of from between 1000 to 1,400 kDa. Evaluations were performed by 6 expert tasters. White wine containing hyaluronic acid was compared to a reference white wine. Tasters found that the samples containing the hyaluronic acid at 250 ppm were slightly higher in overall sweetness and sourness, and slightly higher in perceived acidity.

### Example 13—Cold Brew Coffee

Hyaluronic acid was tested at 250 ppm in a commercial unsweetened cold brew coffee beverage by adding sodium hyaluronate having an average molecular weight of from between 1000 to 1,400 kDa. Evaluations were performed by 6 expert tasters. The beverage containing hyaluronic acid was compared to a reference beverage. Tasters found that the samples containing the hyaluronic acid at 250 ppm were slightly lower in bitterness, slightly higher in mouthcoating and slightly lower in astringency mouthfeel sensations. The same results were seen in a semi-sweetened cold brew coffee beverage.

### Example 14—Carbonated Soft Drink

Hyaluronic acid was tested at 250 ppm in a commercial lemon/lime carbonated soft drink by adding sodium hyaluronate having an average molecular weight of from between 1000 to 1,400 kDa. Evaluations were performed by 5 expert tasters. The soft drink containing hyaluronic acid was compared to a reference soft drink. Tasters found that the samples containing the hyaluronic acid at 250 ppm were slightly lower in astringency and slightly higher in mouthcoating mouthfeel sensations, and lower in sourness.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A method of masking perceived astringency and undesired off-notes imparted by a consumable composition or an additive, including the step of adding to the consumable composition or additive an astringency-masking amount of hyaluronic acid and/or salt thereof, wherein the hyaluronic acid and/or salt thereof has an average molecular weight of at least 500 kDa.

2. The method of claim 1, wherein the amount of hyaluronic acid and/or salt thereof in the consumable composition or additive is from about 50 ppm to about 1000 ppm.

3. The method of claim 1, wherein the hyaluronic acid and/or salt thereof has an average molecular weight of greater than 500 kDa to about 1,500 kDa.

4. The method of claim 1, comprising adding an astringency-masking amount of hyaluronic acid.

5. The method of claim 1, comprising adding an astringency-masking amount of hyaluronic acid salt.

6. The method of claim 1, comprising adding an astringency-masking amount of both hyaluronic acid and a salt thereof.

7. The method of claim 5, wherein the hyaluronic acid salt comprises an alkali metal or an alkaline earth metal.

8. The method of claim 7, wherein the hyaluronic acid salt comprises sodium hyaluronate.

9. The method of claim 1, wherein the hyaluronic acid and/or salt thereof is a powder.

10. The method of claim 9, wherein the hyaluronic acid and/or salt thereof is a spray-dried powder.

11. The method of claim 1, wherein the consumable composition comprises a beverage.

12. The method of claim 11, wherein the beverage comprises a tea or wine.

13. The method of claim 1, wherein the consumable composition comprises a yogurt.

14. The method of claim 1, wherein the consumable composition comprises a meat analogue, pea protein and/or soy protein.

15. A food or beverage additive comprising at least one component that imparts an undesired off-note or astringency and an astringency-masking amount of hyaluronic acid and/or salt thereof, wherein the hyaluronic acid and/or salt thereof has an average molecular weight of at least 500 kDa.

16. The food or beverage additive of claim 15, wherein the amount of hyaluronic acid and/or salt thereof present in the additive is from about 50 ppm to about 1000 ppm.

17. The food or beverage additive of claim 15, wherein the hyaluronic acid or salt thereof has an average molecular weight of greater than 500 kDa to about 1,500 kDa.

18. A consumable composition comprising a consumable base, at least one component that imparts an undesired off-note or astringency, and an astringency-masking amount of hyaluronic acid and/or salt thereof, wherein the hyaluronic acid and/or salt thereof has an average molecular weight of at least 500 kDa.

19. The consumable composition of claim 18, wherein the amount of hyaluronic acid and/or salt thereof incorporated into the consumable composition is from about 50 ppm to about 1000 ppm.

20. The consumable composition of claim 18, wherein the hyaluronic acid and/or salt thereof has an average molecular weight of greater than 500 kDa to about 1,500 kDa.
